(19) United States
(12) Patent Application Publication
(10) Pub. No.: US 2004/0095948 A1
(43) Pub. Date: May 20, 2004

(54) Data return arbitration

(76) Inventor: Chang-Ming Lin, Cupertino, CA (US)

Correspondence Address: FISH & RICHARDSON, PC, 12390 EL CAMINO REAL, SAN DIEGO, CA, 92130-2081, US

(21) Appl. No.: 10/299,948

(22) Filed: Nov. 18, 2002

(51) Int. Cl. H04L 12/28; H04L 12/56

(52) U.S. Cl. 370/412; 370/444

(57) ABSTRACT

A system and method of arbitrating data return between simultaneous replies while maintaining priority over later replies is provided. The method includes receiving data in a plurality of priority buffers, detecting when two or more of the buffers are ready to read, storing unique identifications of the read-ready buffers in an order queue according to a priority of the buffer in which they are stored, and reading the unique identifications in the order queue in a first-in-first-out order.

### BACKGROUND

This invention relates to data return arbitration for use in network processing systems. Microprocessor computing systems are increasingly used in applications that require a large amount of computing capacity. Many types of multiprocessor systems exist, but in general, such systems are characterized by a number of independently running processors that are coupled together over a common bus in order to facilitate the sharing of resources between the processors. Typically, as data are received by the microprocessor, the microprocessor places the data in buffers. An arbiter picks one of the buffers that has data ready and routes the data to the appropriate location. The arbiter attempts to maintain a fair priority to all the buffers that are ready for read-back but can fail to maintain a fair priority if it is busy returning data from one of the buffers and at the same time two or more buffers are filled and ready for read-back.

### DESCRIPTION OF DRAWINGS

FIG. 1 is a block diagram of a processor.

FIG. 2 is a block diagram of the global buses connecting to the gasket.

FIG. 3 is a block diagram of the push interface of the gasket.

FIG. 4 is a flow diagram of an arbitration process.

### DETAILED DESCRIPTION

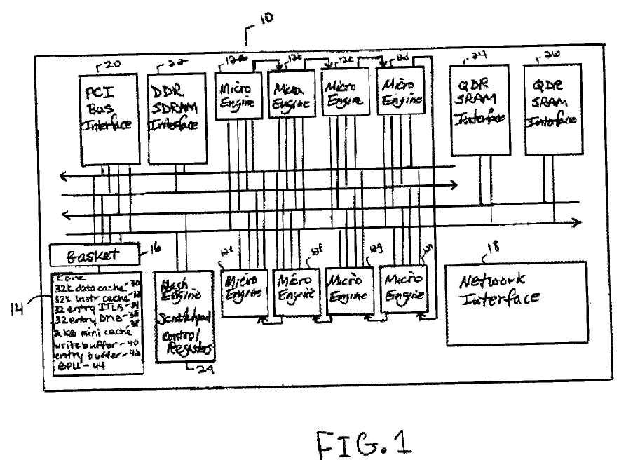

Referring to FIG. 1, an exemplary communication system 10 includes eight multi-threaded packet processing microengines 12a, 12b, 12c, 12d, 12e, 12f, 12g, 12h, a low-power general purpose Xscale microacrchitecture core 14, a gasket 16, and a network interface 18. The system 10 also includes a PCI bus interface 20, a Double Data Rate Synchronous Dynamic Random Access Memory (DDR SDRAM) interface 22, combined hash engine/scratchpad/control registers 24 and Quad Data Rate (QDR) SRAM interfaces 26,28.

The eight microengines 12a, 12b, 12c, 12d, 12e, 12f, 12g, 12h are programmable packet processors and support multithreading up to, for example, eight threads each. These microengines 12a, 12b, 12c, 12d, 12e, 12f, 12g, 12h provide a variety of networking functions in hardware and process data at OC-48 (i.e., 2.488 Gbps) wire speed.

The core 14 executes an instruction set, for example, an ARMv5TE instruction set supporting a (16-bit instructions) and extended media processing Single Instruction Multiple Data (SIMD) instructions. The core 14 has a seven stages integer pipeline and eight stages memory pipeline. The core 14 also supports virtual to physical address translation. One exemplary configuration of the core 14 includes a 32K data cache 30, a 32K instruction cache 32, a 32-entry ITLB 34, a 32-entry DTLB (data translation look aside buffer) 26, a 2KB mini-data cache 38, an 8-entry write buffer 40 and a 4-entry fill and pend buffer 42. The core 14 also contains a branch prediction unit (BPU) 44 that uses a 128-entry branch target buffer and a simple four stages branch prediction scheme.

The core 14 uses instructions for CMB (Core Memory Bus) to communicate with it internal blocks. The CMB is 32-bits with simultaneous 32-bit input path and 32-bit output path generating up to 4.8 Gbytes/sec. @ 600 MHz bandwidth for internal accesses. Remaining internal elements of the system 10 use instructions on a CPP (Command Push Pull) as a global communications protocol bus to pass data between different blocks. The gasket 16 is used to translate instruction on the CMB to instructions on the CCP.

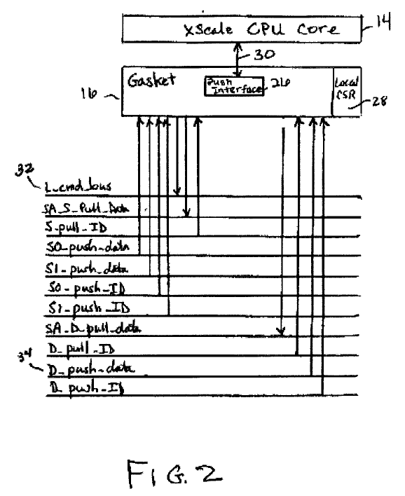

Referring to FIG. 2, the gasket 16 includes a push interface 26 and a set of local control/status registers (CSRs) 28 that include interrupt registers. The CSRs 28 is accessed by the core 14 through a gasket internal bus 30.

The gasket 16 has the following features. Interrupts are sent to the core 14 via the gasket 16, with the interrupt control registers in the CSRs 28 used for masking of interrupts. The gasket 16 converts CMB reads and writes to CPP format. A gasket CPP interface contains one command bus 32, one D_Push bus 34, one D_Pull bus, one S_Push bus, and one S-Pull bus, each of 32 bit data width.

The core 14 has a 32-bit wide data path while the remaining components of the communication system 10 use a 64-bit wide data path. In a DRAM read access, Push interface (Push_IF) looks at Push_Buffer_ID and Index to access Push_ff[4: 0]. The DRAM access also uses DWD (Double Word Data) format and MSW (Most Significant Word) format to decide whether it should ignore incoming data or not in the push operation. In a pull operation, Pull_IF looks at the Pull_Buffer_ID and Index to decode the location of DRAM data. The pull operation also uses DWD format and MSW format to decide if the core 14 should give out dummy data.

DWD fields are also used in SRAM load access. SRAM load access is permitted for either one word (32 bits) or eight words. For one word, for example, DWD is set to ‘0’ so the data will be placed at entry 0 in the buffer. This makes it easier for a buffer read operation. For an eight word load DWS=0 is set to ‘1’ so the Index field is used for a buffer entry index. For example, if Push_IF sees Index is an odd number and DWS=1 and MSW=O then it will drop data.

A reason for having push buffer ID and pull buffer ID as two separate fields is for atomic operations. One atomic CPP command generates one pull and one push operation. Each of these operations can have different buffer IDs. The core 14 has instructions SWP and SWPB that generate an atomic read-write pair to a single address. These instructions are supported for SRAM and Scratch space and also to any other address space if it is done by a Read Command followed by a Write Command.

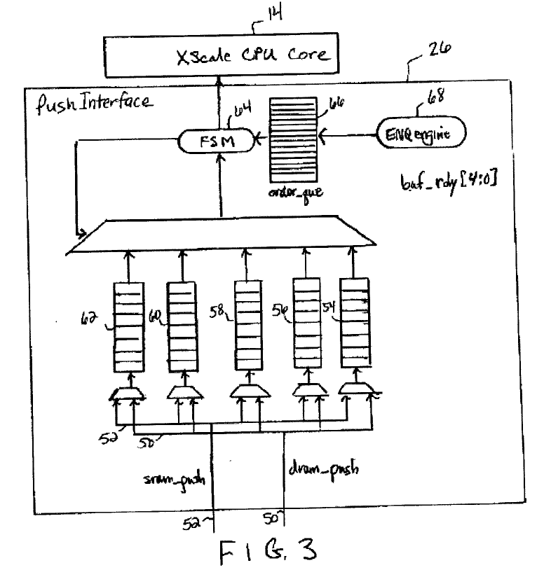

Referring to FIG. 3, the push interface 26 includes two input channels 50, 52 that return either one word or eight words to the push interface 26 simultaneously. In the push interface 26 there are five buffers 54, 56, 58, 60, 62 that buffer incoming data from the two channels 50,52. A read arbiter FSM (finite state machine) 64 selects one of the buffers 54, 56, 58, 60, 62 that has data ready (i.e., buffer full) and routes it to the core 14.

The push interface 26 includes an order queue (order_que) 66. The order queue 66 assigns a relative fair priority to all the buffers 54, 56, 58, 60, 62. When the buffers 54, 56, 58, 60, 62 are ready for read-back and the arbiter 64 is busy returning data from one of the buffers 54, 56, 58, 60, 62, a buffer can still be filling with data before the arbiter 64 finishes a current read. When one of the buffers 54, 56, 58, 60, 62 is ready to read it asserts a buffer ready signal (buf_rdy[4:0]). When an enqueue (ENQ) engine 68 sees two buffer ready signals asserted, the ENQ engine 68 stores the buffer identification (buffer ID) of those ready buffers to the order_que 66 simultaneously. The order in which the ID of each buffer is stored is determined by buffer priority. Each buffer 54, 56, 58, 60, 62 is assigned a number reflecting its relative priority to each other. In an example, buffer 54 (buf0) always has a higher priority than buffers 56, 58, 60, 62, buffer 56 (buf1) always has a higher priority than buffers 58, 60, 62, buffer 58 (buf2) always has a higher priority than buffers 60, 62, and buffer 60 (buf3) always has a higher priority than buffer 62 (buf4).

Therefore, if buf2 58 and buf4 62 are ready at the same time, buf2 58 (i.e., buf2_ID) is placed in entry N of the order queue 66 and buf4 62 (i.e., buf4_ID) in placed in entry N+1 of the order queue 66. Any other buffer that gets filled up subsequently is stored in an entry after N+1 in the order queue 66. At time N+1, bufl 56 and buf3 60 fill up, buf1 56 (i.e., buff1_ID) is placed in entry N+2 in the order queue 66 and buf3 60 (i.e., buf3_ID) is placed in entry N+3 of the order queue 66. By doing this a fair ordering is maintained according to a buffer's ‘filled-up’ time while having a mechanism to arbitrate between two simultaneous fills.

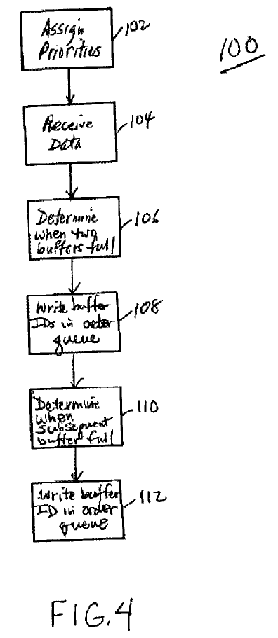

Referring to FIG. 4, a process 100 for arbitrating data return between two simultaneous replies while maintaining priorities over subsequent replies includes assigning (102) relative priorities to buffers and receiving (104) data in the buffers. The process 100 determines (106) when data is simultaneously ready in two buffers and writes (108) the buffer identification into entries of an order queue according to the relative priorities of the buffers containing the data. The process 100 determines (110) when subsequent buffers are filled and writes (112) the corresponding buffer identification in the order queue according to the relative priorities of the buffers containing the data.

Other embodiments are within the scope of the following claims.

What is claimed is:

1. A method of arbitrating data return between two replies comprising:
assigning relative priorities to a plurality of buffers;
receiving data in the buffers;
detecting when two of the buffers are ready for read back; and
storing identification of the two buffers in an order queue according to the relative priority of the buffers.

2. The method of claim 1 further comprising delivering the identification of the buffers in the order queue to a read arbiter finite state machine in first-in-first-out order.

3. The method of claim 1 in which detecting comprises receiving two buffer ready signals in an enqueue engine.

4. The method of claim 1 in which detecting further comprises detecting a third buffer ready for read back.

5. The method of claim 4 in which storing further comprises storing an identification of the third buffer in the order queue according to the relative priority of the buffers.

6. The method of claim 5 further comprising delivering the identification of the third buffer to the read arbiter finite state machine to a processing core.

7. A method comprising:
receiving data in a plurality of priority buffers;
detecting when two or more of the buffers are ready to read;
storing unique identifications of the read-ready buffers in an order queue according to a priority of the buffer in which they are stored; and
reading the unique identifications in the order queue in a first-in-first-out order.

8. The method of claim 7 in which the data are one word in width.

9. The method of claim 7 in which the data are eights words in width.

10. The method of claim 7 in which detecting comprises receiving a buffer ready signal from the buffers.

11. The method of claim 7 further comprising receiving the unique identifications of the order queue in a read arbiter finite state machine.

12. The method of claim 11 further comprising delivering data according to identification of the order queue to a processing core.

13. An interface comprising:
two channels linked to a plurality of buffers, each of the buffers having an assigned priority;
an enqueue engine linked to the buffers;
an order queue linked to the enqueue engine; and
a state machine linked to the buffers and order queue.

14. The interface of claim 13 in which the two channels comprise:
a static random access memory (SRAM) push channel; and
a dynamic random access memory (DRAM) dram push channel.

15. The interface of claim 13 in which the plurality of buffers comprise five buffers.

16. The interface of claim 13 in which the state machine is a read arbiter finite state machine.

17. The interface of claim 13 further comprising a processing core linked to the finite state machine.

18. A network processor comprising:
a plurality of multi-threaded packet processing microengines;
a network interface;
bus interfaces;
memory interfaces; and
a gasket linking the interfaces executing instructions in a command push pull bus format to a microarchitecture core executing instructions in a core memory bus format.

19. The network processor of claim 18 in which the gasket comprises:
two input channels linked to input buffers;
an enqueue engine linked to the input buffers;
an order queue linked to the enqueue engine; and
a state machine linked to the input buffers and order queue.

20. The network processor of claim 19 in which the two input channels are a static random access memory (SRAM) push channel and a dynamic random access memory (DRAM) push channel.

21. The network processor of claim 19 in which the state machine is a read arbiter finite state machine.

22. A computer program product, tangibly stored on a computer-readable medium, for arbitrating data return between simultaneous replies while maintaining priority over subsequent replies, comprising instructions operable to cause a programmable processor to:
assign relative priorities to a plurality of buffers;
receive data in the buffers;
detect when two of the buffers are ready for read back; and
store identification of the two buffers in an order queue according to the relative priority of the buffers.

23. The program product of claim 22 further comprising instructions operable to cause a programmable processor to:
deliver the identification of the buffers in the order queue to a read arbiter finite state machine in first-in-first-out order.

24. A computer program product, tangibly stored on a computer-readable medium, for arbitrating data return between simultaneous replies while maintaining priority over subsequent replies, comprising instructions operable to cause a programmable processor to:
receive data in a plurality of priority buffers;
detect when two or more of the buffers are ready to read;
store unique identifications of the read-ready buffers in an order queue according to a priority of the buffer in which they are stored; and
read the unique identifications in the order queue in a first-in-first-out order.

25. The program product of claim 24 further comprising instructions operable to cause a programmable processor to:
receive the unique identifications of the order queue in a read arbiter finite state machine.

26. The program product of claim 25 further comprising instructions operable to cause a programmable processor to:
deliver data according to identification of the order queue to a processing core.
